(19) United States
(12) Patent Application Publication
(10) Pub. No.: US 2007/0263773 A1
(43) Pub. Date: Nov. 15, 2007

(54) Methods and apparatus for automated testing of a device through a command line interface

(75) Inventors: Ajay Malik, Santa Clara, CA (US); Manas Sharma, Bangalore (IN)

Correspondence Address: INGRASSIA FISHER & LORENZ, P.C., 7150 E. CAMELBACK, STE. 325, SCOTTSDALE, AZ, 85251, US

(73) Assignee: Symbol Technologies, inc.

(21) Appl. No.: 11/368,252

(22) Filed: Mar. 3, 2006

(51) Int. Cl. H04M 1/24; H04M 3/08; H04M 3/22

(52) U.S. Cl. 379/1.01; 379/27.04

(57) ABSTRACT

A method for automated testing of a device (e.g., a router, switch, mobile terminal, barcode reader, or the like) includes creating a metafile, establishing a network connection to the device, parsing the metafile to determine a device command and an expected result, issuing the device command to the command line interface of the device via the network connection; receiving a response from the command line interface of the device via the network connection; comparing the response to the expected result, then logging, to a test summary file, a test result based on said comparing step. The metafile language has a relatively simple vocabulary and syntax, and is thus easy to learn and implement.

### TECHNICAL FIELD

The present invention relates generally to automated testing and, more particularly, to automated testing of network devices via a command line interface.

### BACKGROUND

It is often desirable to perform automated testing of devices such as network components and the like during the design, development, and manufacturing stages. Many devices include a command line interface (CLI) configured to allow certain CLI commands to be issued to the device via a computer or human operator. The operation of the device can then be tested by issuing commands through the CLI and watching for expected (and unexpected) results.

Manual testing by a human operator is undesirable in that the device under test often includes a long list of commands and expressions to be tested, and many of those commands may require multiple and/or iterative testing. It is therefore generally not feasible to implement manual testing on a large scale.

Automated testing may be employed by using a general purpose computer language to develop a series of automated tests. Known systems are unsatisfactory, however, in that they generally require knowledge of a high level language (such as Perl, TCL/Expect, or the like), making the creation of test routines time-consuming, difficult, and expensive. Furthermore, the test programs themselves are often subject to bugs and inadequacies, necessitating the expenditure of time and effort to test and diagnose problems with the test software rather than the device of interest.

Because of the difficulty in developing automated testing, such testing is typically performed late in the development process. As a result, product problems are often not found until much later than necessary, leading to added time and expense.

Accordingly, it is desirable to provide quick, easy-to-learn systems and methods for developing automated test plans for devices such as network devices. Furthermore, other desirable features and characteristics of the present invention will become apparent from the subsequent detailed description and the appended claims, taken in conjunction with the accompanying drawings and the foregoing technical field and background.

### BRIEF SUMMARY

In accordance with one embodiment of the present invention, a method for automated testing of a device (e.g., a router, switch, mobile terminal, barcode reader, or the like) includes: creating a metafile; establishing a network connection to the device; parsing the metafile to determine a device command and an expected result; issuing the device command to the command line interface of the device via the network connection; receiving a response from the command line interface of the device via the network connection; and comparing the response to the expected result; and logging, to a test summary file, a test result based on this comparison.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a test system in accordance with one embodiment of the present invention; and

FIGS. 2A-2B depict an exemplary process in accordance with one embodiment of the present invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions.

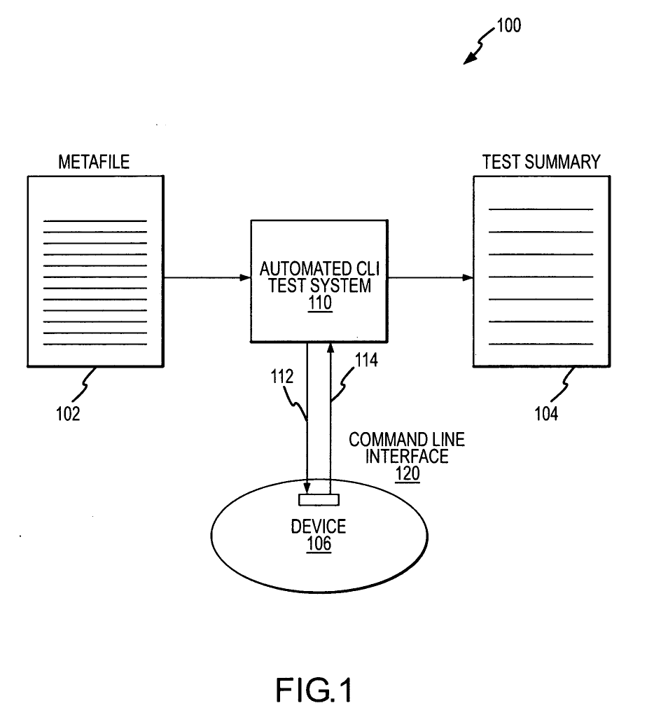

Referring to the conceptual block diagram shown in FIG. 1, an automated testing environment 100 in accordance with one embodiment of the present invention generally includes an automated command line interface test apparatus (or simply “test system,” or simply “system”) 110 configured to communicate via a network connection 112, 114 with a network device (or simply “device”) 106. Test system 110 is capable of accepting a metafile 102, parsing the metafile to determine device commands (or “CLI commands”), determining one or more expected results relating to the desired tests, then issuing the device commands 112 to device 106 via a command line interface 120.

Device 106 then reacts in some manner to the issued device commands and returns respective responses 114, which are received by test system 110. Test system 110 compares the responses with the expected results to produce a log or a test summary 104. As described in further detail below, metafile 102 is created using a relatively simple vocabulary of commands and expressions and using a highly-intuitive syntax, thereby allowing complex test cases to be performed with minimal knowledge of the underlying high-level language.

Metafile 102 may be any type of data file stored in any machine-readable medium. In one embodiment, metafile 102 is a conventional text file comprising a number of lines of text, white space, carriage-returns, and/or any other special characters traditionally included in known character sets (e.g., ASCII, Unicode, Windows, etc.). Toward this end, metafile 102 may be created by the user via any convenient text editor or other authoring software.

Metafile 102 is created using a relatively low-complexity metafile language—e.g., a metafile language with a relatively small set of commands as compared to conventional high level languages. In one embodiment, metafile 102 includes a series of lines of text comprising a command string and an expression string separated by a delimiter, where the command string is selected from a vocabulary of commands in the metafile language, and the expression string is an expression as that term is conventionally used in the art.

In one embodiment, for example, the set of commands (and description of the commands) are as set forth in the following table. The various commands are generally either self-explanatory or described below in conjunction with the examples.

| Command | Description |
|---|---|
| V | Version compatibility line. |
| D | Description of test being performed on device |
| L | Add a message to the log file |
| C | Command |
| !C | Command for a negative test case |
| TC | Add test case identifier to the log file |
| W | Wait for response from device |
| !W | Ignore timeout error |
| S | Show command |
| !S | Show command for a negative test case. (for |
| | positive test cases “Invalid input detected” is |
| | considered error |
| E | Exec command. Executes an external command |
| | via the shell. |
| CE | Check Exec Command. Used in pair with W:: |
| | and look for R:: or !R:: in output of E command |
| EVAL | Evaluate expression as ‘in built’ Perl code |
| R | Expected result |
| !R | Not expected result |
| OT | Open a telnet session |
| CT | Close a telnet session |
| VERIFY | Verify if the command shows up in running |
| | config |
| PROCESSTEST | Do a process test |
| CHECKPOINT | Mark all resources for comparison later. all later |
| | checkpoints compare against previous ones |
| INCLUDE | Include another metafile |
| FUNCTION | Include other functions written as metafiles |
| REQUIRE | Include Perl code extensions |
| IF ELSE | If expression evaluates to non-zero, all code |
| ENDIF | between IF and ELSE, or IF and ENDIF if no |
| | ELSE present, is executed |

Thus, metafile 102 might include a series of sequential lines such as:

C:: show version

R:: 1.1

W::

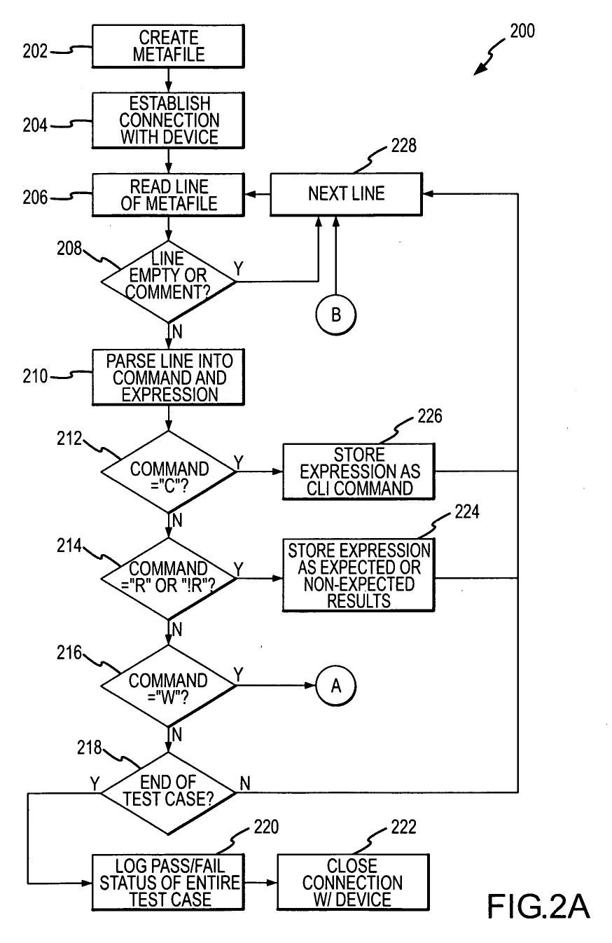

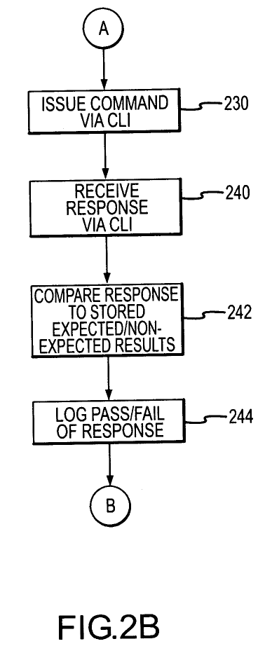

In this simplified example, the first line includes a command string “C” followed by a delimiter “::” which is followed by an expression string “show version.” Similarly, the second line includes a command string “R” followed by the delimiter “::” followed by an expression “1.1”. As described further below in conjunction with FIG. 2 (and with momentary reference to the table shown above), when the “W” command is encountered, the CLI command “show version” is issued to CLI of device 106, then the system examines the response back from device 106 to see if the response includes the expected string of characters, “1.1”. The “W” command instructs the system to wait for the response. In this metafile language embodiment, a “C” command is followed by a “R” (or “!R”) command and a “W” command.

In accordance with another embodiment of the invention, various flow control structures such as conditionals, loops, and the like are incorporated into the metafile language such that certain tests and CLI commands can be tested multiple times and/or using expressions with incrementing variables. In one embodiment, for example, a loop structure employing a “REPEAT” command is used as follows:

EVAL:: $i=0;

REPEAT::

. . .

. . . inserted code

. . .

EVAL:: $i++;

UNTIL:: $i<5

In this example, the variable i is initialized to zero, then incremented using the EVAL command within a REPEAT/UNTIL loop as shown. Loops within loops are also permissible.

It will be appreciated that the particular choice of vocabulary (“C”, “R”, etc.) is arbitrary, as is the particular delimiter (“::”) and syntax (command+delimeter+expression). The metafile language described above is merely exemplary, and is not intended to limit the range of commands, expressions, and syntax that may be employed to implement the present invention.

Referring again to FIG. 1, test system 110 may include any combination of hardware, software, and firmware capable of performing the tasks set forth below. That is, the method steps described below in connection with the embodiments disclosed herein may be embodied directly in hardware, in firmware, in a software module executed by a processor, or in any practical combination thereof. Furthermore, a software module may reside in RAM memory, flash memory, ROM memory, EPROM memory, EEPROM memory, registers, a hard disk, a removable disk, a CD-ROM, or any other form of storage medium known in the art. An exemplary storage medium can be coupled to a processor such that the processor can read information from, and write information to, the storage medium. In the alternative, the storage medium may be integral to the processor.

In one embodiment, test system 110 includes a general-purpose computer with conventional components and an operating system (e.g., Windows, Linux, etc.) that executes a software module written in a high-level language. Example high-level languages include, for example, Perl, TCL/Expect, Java, C++, and the like. In one embodiment, for example, test system 110 includes a software module consisting, in part, of a Perl script operating on a conventional personal computer that is configured to establish a network connection with device 106.

Device 106 may be any type of device having a command line interface (CLI). In this regard, a CLI is a method of interacting with a device that allows a sequence of characters to be entered on a single line, including various parameters, commands, variables, flags, switches, and the like. The CLI may be accessed via a keyboard or any other convenient method provided by the device. In the illustrated embodiment, CLI 120 is accessible via a network connection (112, 114), i.e., any wired or wireless network connection now known or later developed.

In one embodiment, CLI 120 is accessed via a packet-switched network—e.g., via a Telnet session established between system 110 and device 106, both of which will typically have its own IP address within the network (see example metafile below). For the purpose of clarity, the network in FIG. 1 is shown as a two-way network connection (112, 114) between device 106 and test 110. It will be understood, however, that the network might include various other components and nodes, such as servers, workstations, routers, and the like.

Device 106 may be, for example, a network component such as a switch, a gateway, a router, or a wireless access point, but might also be a portable device such as a mobile computer, a personal data assistant, a barcode reader, or the like. Depending upon the nature of device 106, the range of possible CLI commands and responses that are supported by device 106 will vary. However, the present invention contemplates the use of any arbitrary device CLI, as long as that CLI and its range of commands is known a priori. The particular CLI commands sent to device 106 are simply set forth in metafile 102 (e.g., as the expression to the “C” command). Similarly, the expected responses to the issued CLI commands are typically known a priori, and form the basis of the test results logged in test summary 104.

Test summary 104 serves to record the results of the various tests performed by system 110, and may be any form of file, hard-copy output, computer media, or visual indicator. In one embodiment, test summary 104 is a text file that includes lines of text specifying whether the tests set forth in metafile 102 passed or failed, and/or whether any defined test cases (i.e., groups of individual tests) passed or failed. In accordance with the metafile language described above, test summary 104 may include additional helpful information, such as a test description (“D” command) or an arbitrary log message (“L” command).

Having thus given a description of the various components of an exemplary system, a test method in accordance with one embodiment of the present invention will now be described in conjunction with FIGS. 2A-2B. In this regard, it should be appreciated that the illustrated method may include any number of additional or alternative tasks, the tasks shown in FIGS. 2A-2B need not be performed in the illustrated order, and process 200 may be incorporated into a more comprehensive procedure or process having additional functionality not described in detail herein.

With reference to FIGS. 1, 2A, and 2B, a suitable metafile 102 is first created (202). As mentioned above, metafile 102 may be created using a text editor or any other convenient authoring program. For example, metafile 102 may be created using a computer system on which test system 110 is implemented.

Next, the system established a connection with device 106 (204). In one embodiment, this connection comprises a connection (such as Telnet and/or ssh) over a packet-switched network such as the Internet. Any other such wired or wireless connection may be employed.

Once the connection is established, and any preliminary hand-shaking is completed, a line of text from metafile 102 is read by the system (206). If the line is empty (208), or includes a comment (e.g., a line beginning with a “#” character), processing continues with steps 228 and 206, and the next line of metafile 102 is read by the system.

The line of text is then parsed into a command string and expression string (210), where the expression string may be empty. As mentioned previously, the syntax may vary, but in one embodiment it is of the form command string+delimiter+expression string, where the delimiter is a pair of colons characters.

If, at decision step 212, the command string is a “C” (or any other string intended to designate a command), the system stores the expression string as a CLI command to be used later (226) then continues to steps 228 and 206, where the next line is processed.

If, at decision step 214, the command string is an “R” or “!R” (or any other combination of strings intended to indicate the expected or non-expected results), the system stores the expression string as an expected or non-expected result (224) then continues to steps 228 and 206, where the next line is processed.

If, at decision step 216, the command string is a “W” (or any other string intended to designate waiting), the system continues with step 230, where a CLI command (or “device command”) corresponding to the previously-stored “C::” expression is sent via CLI 120 to device 106. A response from device 106 is then received back via CLI 120 (240), and that response is compared to the expected response previously stored from the preceding “R::” and “!R::” command (242). If the received response contains the string of characters specified in the stored expected result, and it does not contain the string of characters specified in the non-expected results (if any), then a “PASS” or equivalent notation is logged for use by test summary 104; otherwise, a “FAIL” or equivalent notation is logged (244). After this logging step, processing continues again with steps 228 and 206, where the next line of metafile 102 is read.

If, at decision step 218, the end of metafile 102 is reached, or the end of a test case is reached (e.g., as indicated by the string “TC::” alone on a line), then the pass/fail status of the entire test case is logged (220). That is, if all tests within a test case achieved a PASS designation, then the test case is designated as a PASS. If at least one test within a test case achieved a FAIL designation, however, then the test case is designated as a FAIL. After test summary 104 is appropriately updated, the connection is closed with device 106 (222).

It will be appreciated that the method shown in FIGS. 2A and 2B address only a portion of the command types used by the system, and that the method might also perform a number of other procedures (e.g., other procedures associated with the commands listed in the table above). The system might also provide flow control, conditional statements, and might also parse expressions for certain high-level language commands (e.g., regular expressions, Perl commands, C commands, and the like).

What follows is an example metafile useful in illustrating the exemplary metafile language set forth above. For convenience, line numbers are included, although these line numbers would not typically be included in the text file itself. Comments are indicated using “#” as the first character in a line.

| | |
|---|---|
| 1 | ################################### |
| 2 | |
| 3 | #Version command |
| 4 | V::1.0 |
| 5 | |
| 6 | # Specify the test case number. In the final report, it |
| | returns |
| 7 | # logical ‘and’ of PASS or FAIL for all commands in a |
| | test case |
| 8 | TC::TC0001 |
| 9 | |
| 10 | # Open telnet session |
| 11 | OT::192.168.1.10 |
| 12 | |
| 13 | # Add log message |
| 14 | L::Verify http is currently enabled |
| 15 | |
| 16 | C::show ip http |
| 17 | #look for the word ‘enabled’ in the output |
| 18 | R::enabled |
| 19 | W:: |
| 20 | |
| 21 | L::Verify thttpd process has restart count of 1 |
| 22 | C::show pm |
| 23 | R::thttpd[\W]*1 |
| 24 | W:: |
| 25 | |
| 25 | # This test case is complete. If the file has another test |
| | case e.g. TC0002, |
| 26 | # add command TC::TC0002 instead of TC:: which means |
| | previous test |
| 27 | # case has ended and new one has started. Output of the |
| | program is |
| 28 | # PASS or FAIL for each # Test case |
| 29 | |
| 30 | TC:: |
| 31 | # close the Telnet session. Following command is optional |
| | and if not |
| 32 | # specified at end of file then is assumed. |
| 33 | CT:: |
| 34 | |
| 35 | ################################### |

As described previously, the metafile is processed by the system line-by-line. Thus, lines 1-3 would be ignored by the system (per step 208 of FIG. 2A) as they are either blank or contain comments. Line 4 specifies the version, and is preferably logged as part of the test summary. In line 8, the test case is specified using the “TC” command. In this example, the test case is labeled “TC0001”. The individual tests that follow are then considered as part of this test case.

In line 11, the “OT” command is used to open a Telnet connection to the device being tested. In this example, the target device has an IP address of 192.168.1.10. The system then established a connection with the address over the TCP/IP network in the conventional manner. The IP address of the device being tested may alternatively be specified in the command line of the testing software module when invoked.

In line 14, a log message is included using the “L” command. That is, the text “Verify http is currently enabled” is logged to the test summary file.

In lines 16-19, the first real test is performed. First, in line 16, the “C” command is used to specify the CLI command “show ip http”, which is stored by the system. Next, in line 18, the expected result of “enabled” is specified using the “R” command. Finally, in line 19, the “W” command (wait command) waits for a response from the device (i.e., a response to the “show ip http” CLI command), then logs the PASS/FAIL result based upon whether the text string includes the word “enabled”.

In lines 21-24, the system similarly adds a log message via the “L” command, then tests the device using a “show pm” CLI command with an expected result of “thhtpd[\W]*1. In this regard, the expected result is framed as a regular expression, as that term is used in the art to specify certain pattern-matching capabilities. In the illustrated embodiment, this regular expression of the type commonly used in connection with Perl scripts.

In line 30, the “TC” command is used to terminate the test case. That is, lines 16-24 include two individual tests that are part of a single test case “TC0001”. Additional test cases may be included after TC0001, e.g., by declaring “TC::TC0002” rather than using the terminator “TC::”.

Finally, in step 33, the “CT” command is used to close the telnet connection to the device under test. This command is optional, and is assumed if not specified by the end of the metafile.

While at least one example embodiment has been presented in the foregoing detailed description, it should be appreciated that a vast number of variations exist. For example, while the illustrated invention utilizes the test system to interpret the metafile line-by-line, the system may in fact create an intermediate high-level language file (e.g., a Perl file) which can be used for testing independent of the metafile. Alternatively, the metafile may be used to create a compiled executable file.

It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for automated testing of a network device having a command line interface, said method comprising:
creating a metafile;
establishing a network connection with the device;
parsing said metafile to determine a device command and an expected result;
issuing said device command to said command line interface of the device via said network connection;
receiving a response from said command line interface of the device via said network connection;
comparing said response to said expected result;
logging, to a test summary file, a test result based on said comparing step.

2. The method of claim 1, wherein said metafile is partitioned into a plurality of test cases, and wherein said method further includes logging, to said test summary file, a test case result based on said comparing step.

3. The method of claim 1, wherein said creating step includes creating a plurality of lines of text that include a command string and an expression string.

4. The method of claim 3, wherein said parsing step includes determining the device command from one of said expression strings of one of said lines having a predetermined command string.

5. The method of claim 3, wherein said parsing step includes determining the expected result from one of said expression strings of one of said lines having a predetermined command string.

6. The method of claim 3, wherein said lines of text include a first line and a second line subsequent to said first line, said method including determining the device command from said first line, and determining the expected result from said second line.

7. The method of claim 3, wherein said lines of text include said command string followed by a delimiter followed by said expression string.

8. The method of claim 1, wherein said step of establishing a connection includes establishing a Telnet connection, a serial console connection, or a secure ssh connection.

9. A system for automated testing of a network device of the type having a command line interface (CLI), said system comprising:
a test apparatus configured to:
establish a network connection with the device via the network connection;
parse a text metafile to determine a device command and an expected result;
issue said device command to said command line interface of the device via said network connection;
receive a response from said command line interface of the device via said network connection;
compare said response to said expected result and log, to a test summary file, a test result based on said comparing step.

10. The system of claim 9, wherein said test apparatus includes a processor, a memory, an input output device, and a display.

11. The system of claim 9, wherein said test apparatus is further configured to log, to said test summary file, a test case result based on said comparing step.

12. The system of claim 9, wherein said test apparatus is configured to establish a network connection with the device via a packet-switched network.

13. The system of claim 9, wherein said network connection is a ssh session a serial console connection, or a secure ssh connection.

14. The system of claim 9, wherein the network connection is a wireless connection.

15. The system of claim 14, wherein the device is a network component selected from the group consisting of routers, gateways, switches, mobile devices, and wireless access points.
